(19) United States
(12) Patent Application Publication
(10) Pub. No.: US 2011/0109583 A1
(43) Pub. Date: May 12, 2011

(54) Capacitive Touch Screen Panel

(76) Inventor: Yong Hoon Lee, Yongin-Si (KR)

(21) Appl. No.: 12/747,375

(22) PCT Filed: Sep. 25, 2009
(86) PCT No.: PCT/KR2009/005473

§ 371 Date: Dec. 21, 2010

(30) Foreign Application Priority Data
Feb. 23, 2009 (KR) 10-2009-0014912

(51) Int. Cl. G06F 3/045

(52) U.S. Cl. 345/174

(57) ABSTRACT

Provided is a capacitive touch-screen panel. The capacitive touch-screen panel includes a first substrate having a screen region and an inactive region, a first transparent electrode pattern unit disposed in the screen region of a first lateral surface of the first substrate, a first outer electrode interconnection formed in the inactive region of the first lateral surface of the first substrate and electrically connected to the first transparent electrode pattern unit, a second substrate having a first lateral surface bonded with a second lateral surface of the first substrate using an interlayer adhesive, the second substrate having a screen region and an inactive region, a second transparent electrode pattern unit disposed on the screen region of a second lateral surface of the second substrate, and a second outer electrode interconnection formed in the inactive region of a second lateral surface of the second substrate and electrically connected to the second transparent electrode pattern unit. The capacitive touch-screen panel is configured to sense a touched position with a variation in capacitance due to a contact with the first and second transparent electrode pattern units. As a result, malfunctions from occurring due to a state of contact with an upper portion of an electrode unit of a touch screen and malfunctions and damage from occurring due to scratches and static electricity during a contact with the touch screen may be prevented. Further, the fabrication cost of a touch screen may be efficiently reduced, and the fabrication process of a touch-screen panel may be greatly simplified.

### CROSS-REFERENCE TO RELATED APPLICATION

This application claims priority to and the benefit of Korean Patent Application No. 2009-14912, filed on Feb. 23, 2009, the disclosure of which is incorporated herein by reference in its entirety.

### BACKGROUND

1. Field of the Invention

The present invention relates to a capacitive touch-screen panel, and more particularly, to a capacitive touch-screen panel capable of preventing malfunctions from occurring due to a state of contact with an upper portion of an electrode unit of a touch screen, preventing malfunctions and damage from occurring due to scratches and static electricity during a contact with the touch screen, effectively reducing fabrication costs of the touch screen, and greatly simplifying the entire process of fabricating the touch-screen panel.

2. Discussion of Related Art

In general, a touch screen is an input apparatus that allows all types of people to dialogically and intuitively manipulate a computer using only contacts of a finger with buttons indicated on a display unit.

Touch screens are divided into resistive touch screens, capacitive touch screens, infrared touch screens, and ultrasonic touch screens. Currently, resistive touch screens are being widely used, while capacitive touch screens are being used to minimize thicknesses.

Specifically, a capacitive touch screen includes a conductive light transmission plate formed of indium tin oxide, an electrode unit formed of powdered silver paint on an edge of the conductive light transmission plate, and an insulating coating unit configured to insulate a lower portion of the electrode unit from other elements.

Meanwhile, the conductive light transmission plate, includes an ITO film formed of a light-transmissive resin and an ITO coating layer formed by coating a conductive material under the ITO film.

In the case of the above-described conventional capacitive touch screen, when a finger contacts a top surface of the conductive light transmission plate, each of electrodes disposed on four sides of the top surface of the conductive light transmission plate can sense a variation in capacitance due to the contact with the finger to sense a touched position.

However, when contacting an electrode unit of the above-described conventional touch screen, the touch screen may operate irrespective of a user's intentions due to degradation in linearity at the electrode unit.

Furthermore, even when a protection layer is formed on the top surface of the conductive light transmission plate to prevent scratch damages, the protection layer is formed of a simple synthetic resin so that a user cannot appropriately cope with static electricity applied during a contact of the user with the capacitive touch screen, thus causing initial malfunctions and damage.

### SUMMARY OF THE INVENTION

The present invention is directed to a capacitive touch-screen panel capable of preventing malfunctions from occurring due to a state of contact with an upper portion of an electrode unit of a touch screen, preventing malfunctions and damage from occurring due to scratches and static electricity during a contact with the touch screen, effectively reducing fabrication costs of the touch screen, and greatly simplifying the entire process of fabricating the touch-screen panel.

According to an aspect of the present invention, there is provided a capacitive touch-screen panel including: a first substrate having a screen region and an inactive region; a first transparent electrode pattern unit disposed in the screen region of a first lateral surface of the first substrate; a first outer electrode interconnection formed in the inactive region of the first lateral surface of the first substrate and electrically connected to the first transparent electrode pattern unit; a second substrate having a first lateral surface bonded with a second lateral surface of the first substrate using an adhesive, the second substrate having a screen region and an inactive region; a second transparent electrode pattern unit disposed on the screen region of a second lateral surface of the second substrate; and a second outer electrode interconnection formed in the inactive region of a second lateral surface of the second substrate and electrically connected to the second transparent electrode pattern unit. The capacitive touch-screen panel is configured to sense a touched position with a variation in capacitance due to a contact with the first and second transparent electrode pattern units.

According to another aspect of the present invention, there is provided a capacitive touch-screen panel including: a first substrate having a screen region and an inactive region; a first transparent electrode pattern unit disposed in the screen region of a first lateral surface of the first substrate; a second substrate having a first lateral surface bonded with a second lateral surface of the first substrate, the second substrate having a screen region and an inactive region; a second transparent electrode pattern unit disposed in the screen region of a second lateral surface of the second substrate; a first outer electrode interconnection disposed in the inactive region of the second lateral surface of the second substrate and electrically connected to the first transparent electrode pattern unit through at least one via hole; and a second outer electrode interconnection disposed in the inactive region of the second lateral surface of the second substrate and electrically connected to the second transparent electrode pattern unit. The capacitive touch-screen panel is configured to sense a touched position with a variation in capacitance due to a contact with the first and second transparent electrode pattern units.

An external driver may be bonded to the inactive region of the second lateral surface of the second substrate and electrically connected to the first and second outer electrode interconnections.

The capacitive touch-screen panel may further include: a transparent substrate having a first lateral surface bonded to the second lateral surface of the second substrate by an interlayer adhesive, the transparent substrate having a screen region and an inactive region; and a shielding electrode pattern configured to remove a noise signal and disposed in the screen region of a second lateral surface of the transparent substrate.

The capacitive touch-screen panel may further include an outer shielding electrode interconnection disposed in the inactive region of the second lateral surface of the transparent substrate and electrically connected to the shielding electrode pattern.

The capacitive touch-screen panel may further include: a transparent substrate having a screen region and an inactive region; a shielding electrode pattern configured to remove a noise signal and disposed in the screen region of a first lateral surface of the transparent substrate; and an outer shielding electrode pattern disposed in the inactive region of the first lateral surface of the transparent substrate and electrically connected to the shielding electrode pattern. The first lateral surface of the transparent substrate on which the shielding electrode pattern and the outer shielding electrode interconnection are disposed may be bonded to the second lateral surface of the second substrate by an interlayer adhesive.

Each of the first and second substrates may be a transparent film formed of at least one selected from the group consisting of glass, polyethylene terephthalate (PET), polyethylene naphthalate (PEN), polyimide (PI), and acryl.

According to still another aspect of the present invention, there is provided a capacitive touch-screen panel including: a substrate having a screen region and an inactive region; first and second transparent electrode pattern units respectively disposed in the screen regions of first and second lateral surfaces of the substrate; and first and second outer electrode interconnections disposed in the inactive regions of the first and second lateral surfaces of the substrate and electrically connected to the first and second transparent electrode pattern units, respectively. The capacitive touch-screen panel is configured to sense a touched position with a variation in capacitance due to a contact with the first and second transparent electrode pattern units.

According to yet another aspect of the present invention, there is provided a capacitive touch-screen panel including: a substrate having a screen region and an inactive region; first and second transparent electrode pattern units respectively disposed in the screen regions of first and second lateral surfaces of the substrate; a first outer electrode interconnection disposed in the inactive region of the second lateral surface of the substrate and electrically connected to the first transparent electrode pattern unit through at least one via hole; and a second outer electrode interconnection disposed in the inactive region of the second lateral surface of the substrate and electrically connected to the second transparent electrode pattern unit. The capacitive touch-screen panel is configured to sense a touched position with a variation in capacitance due to a contact with the first and second transparent electrode pattern units.

An external driver may be bonded to the inactive region of the second lateral surface of the substrate and electrically connected to the first and second outer electrode interconnections.

The capacitive touch-screen panel may further include: a transparent substrate having a first lateral surface bonded to the second lateral surface of the substrate by an interlayer adhesive, the transparent substrate having a screen region and an inactive region; and a shielding electrode pattern configured to remove a noise signal and disposed in the screen region of the lateral surface of the transparent substrate.

The capacitive touch-screen panel may further include an outer shielding electrode interconnection disposed in the inactive region of the second lateral surface of the transparent substrate and electrically connected to the shielding electrode pattern.

The capacitive touch-screen panel may further include: a transparent substrate having a screen region and an inactive region; a shielding electrode pattern configured to remove a noise signal and disposed in the screen region of the first lateral surface of the transparent substrate; and an outer shielding electrode interconnection disposed in the inactive region of the first lateral surface of the transparent substrate and electrically connected to the shielding electrode pattern. The first lateral surface of the transparent substrate on which the shielding electrode pattern and the outer shielding electrode interconnection are disposed may be bonded to a second lateral surface of the substrate by an interlayer adhesive.

The substrate may be a transparent film formed of at least one selected from the group consisting of glass, PET, PEN, PI, and acryl.

Each of the first and second transparent electrode pattern units may be formed of at least one selected from the group consisting of indium tin oxide (ITO), indium zinc oxide (IZO), aluminum (Al)-doped ZnO (AZO), carbon nanotubes (CNT), poly(3,4-ethylenedioxythiophene) (PEDOT), silver (Ag) transparent ink, and copper (Cu) transparent ink.

A plurality of first transparent electrode patterns of the first transparent electrode pattern unit may be spaced a predetermined distance apart from one another in a widthwise direction and connected to one another in a lengthwise direction such that vertices of a plurality of triangular or rectangular sensing pads are spaced a predetermined distance apart from in a lengthwise direction, and a plurality of second transparent electrode patterns of the second transparent electrode pattern unit may be spaced a predetermined distance apart from one another in a lengthwise direction at right angles to one another between the respective first transparent electrode patterns and connected to one another in a widthwise direction such that vertices of a plurality of triangular or rectangular sensing pads are spaced a predetermined distance apart from each other so that the first and second transparent electrode pattern units can form a right-angled grating shape.

The shielding electrode pattern may be formed in a plate or mesh shape.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIGS. 1 through 4 are cross-sectional views of touch screens including capacitive touch-screen panels according to exemplary embodiments of the present invention;

FIG. 5 is a plan view of a capacitive touch-screen panel according to a first exemplary embodiment of the present invention;

FIGS. 6 and 7 are plan views of only first and second substrates of FIG. 5, respectively;

FIG. 8 is a longitudinal sectional view of a capacitive touch-screen panel according to a first exemplary embodiment of the present invention;

FIG. 9 is a cross-sectional view taken along line A-A′ of FIG. 5;

FIG. 10 is a plan view of a capacitive touch-screen panel according to a second exemplary embodiment of the present invention;

FIGS. 11 and 12 are plan views of only first and second substrates of FIG. 10, respectively;

FIG. 13 is a longitudinal sectional view of a capacitive touch-screen panel according to a second exemplary embodiment of the present invention; and

FIG. 14 is a cross-sectional view taken along line B-B′ of FIG. 10.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

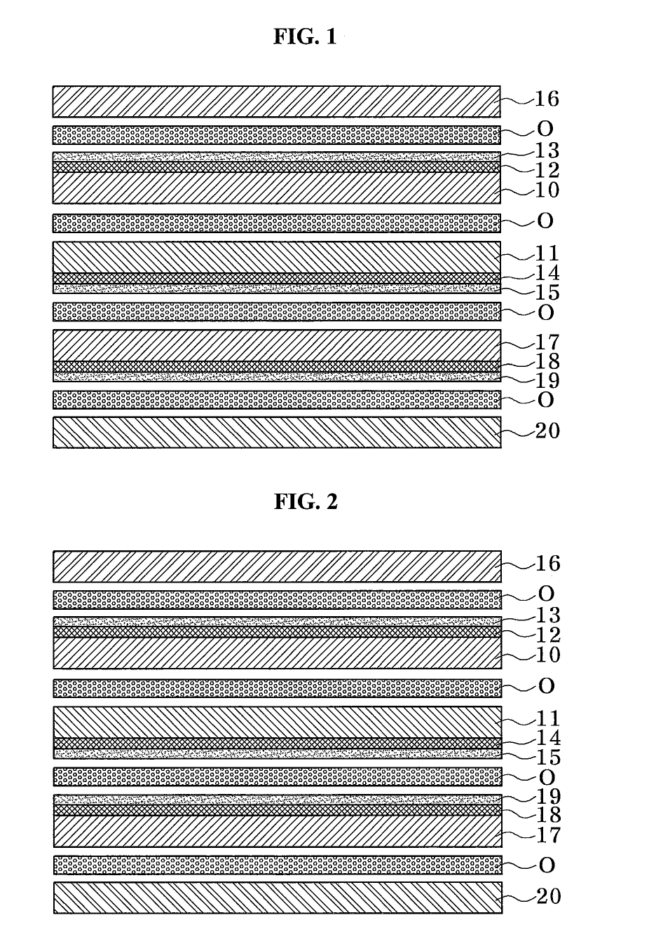

FIGS. 1 through 4 are cross-sectional views of touch screens including capacitive touch-screen panels according to exemplary embodiments of the present invention.

Referring to FIG. 1, a capacitive touch-screen panel according to exemplary embodiments of the present invention may be configured such that first lateral surfaces of first and second substrates 10 and 11 are bonded to each other by an interlayer adhesive O. Specifically, a first outer electrode interconnection 13 may be formed in a specific shape in a specific region of a second lateral surface of the first substrate 10 and electrically connected to a first transparent electrode pattern 12. A second outer electrode interconnection 15 may be formed in a specific shape in a specific region of a second lateral surface of the second substrate 11 and electrically connected to a second transparent electrode pattern 14.

Also, a plate-type window screen 16 may be bonded with the second lateral surface of the first substrate 10 using the interlayer adhesive O to allow a finger or specific object (e.g., a stylus) to contact the capacitive touch-screen panel.

Furthermore, a third substrate 17 having a first lateral surface bonded with the second lateral surface of the second substrate 11 by the interlayer adhesive O may be formed in a specific shape so as to remove an electromagnetic interference (EMI) noise. An outer shielding electrode interconnection 19 may be formed in a specific shape in a specific region of a second lateral surface of the third substrate 17 and electrically connected to a ground or a shielding electrode pattern 18 configured to remove a noise signal.

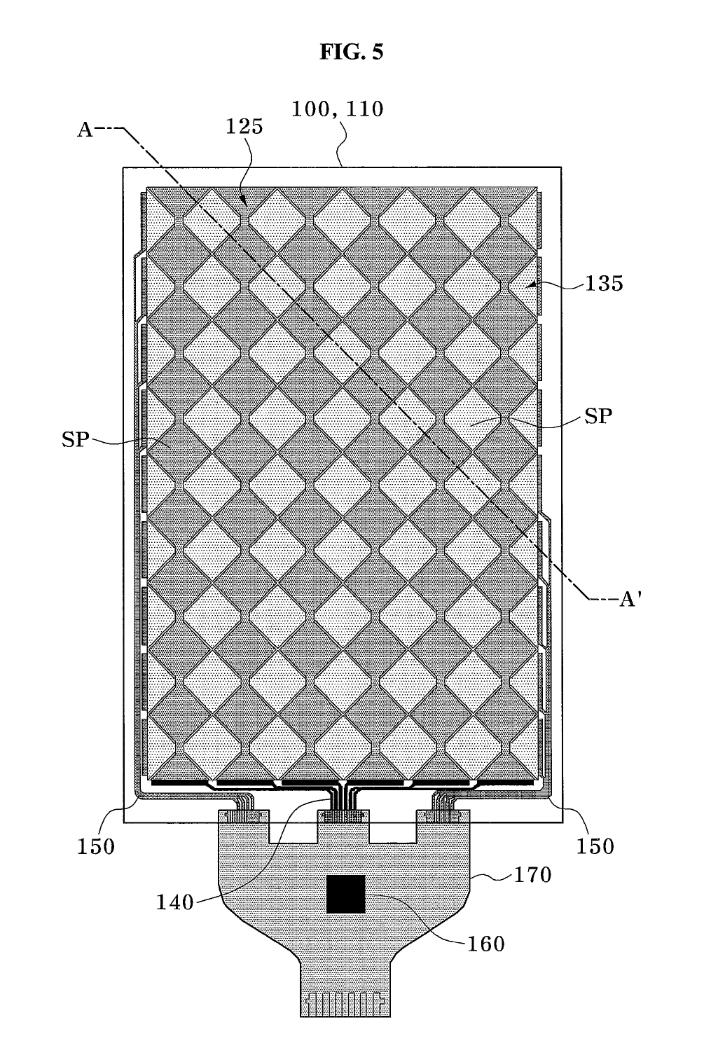

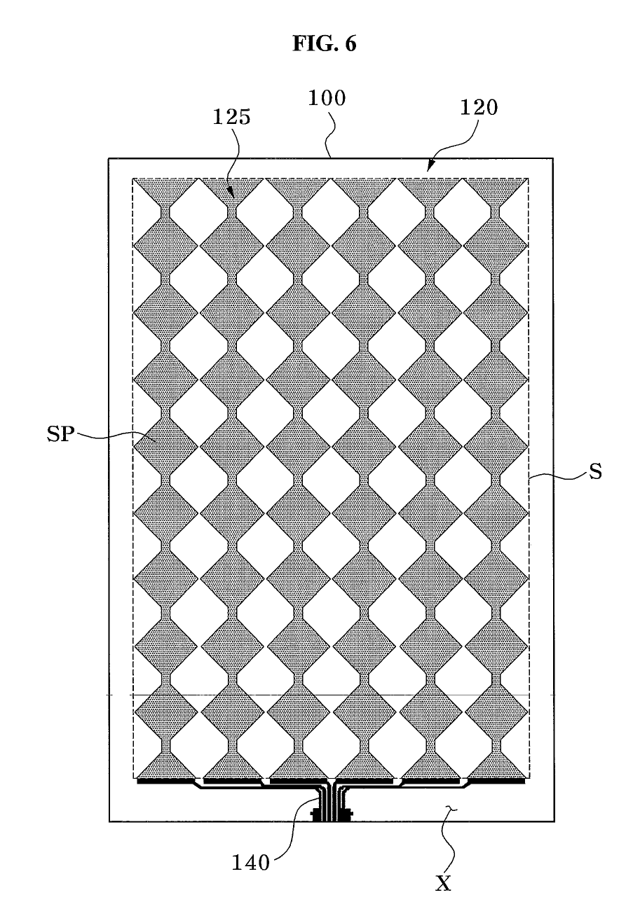

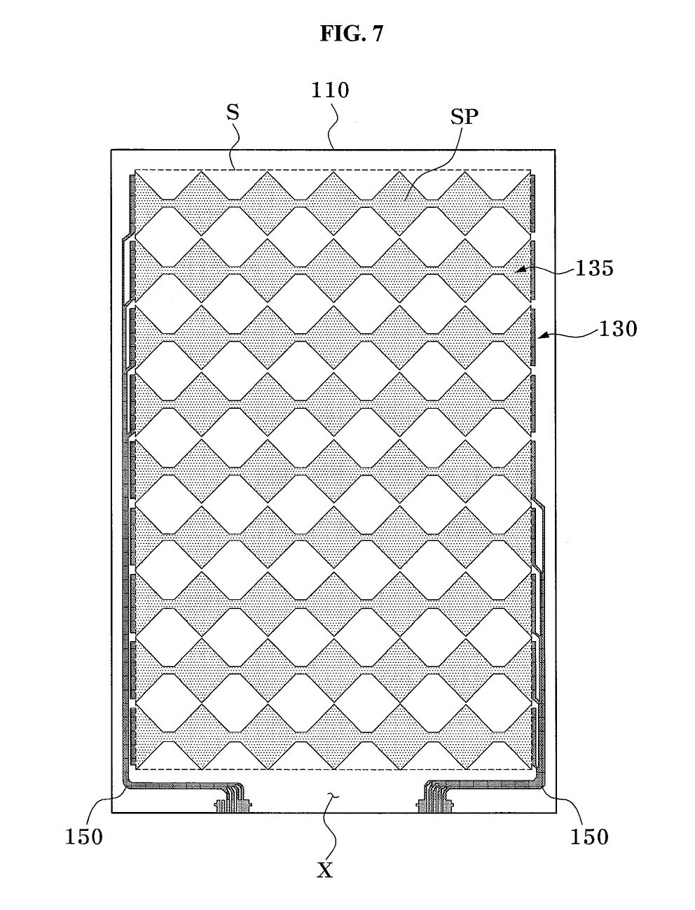

Although the outer shielding electrode interconnection 19 may be electrically connected to an external driver (170 in FIG. 5) or an external printed circuit board (PCB), the present invention is not limited thereto. Thus, the outer shielding electrode pattern 19 may be removed, and the shielding electrode pattern 18 may be electrically connected and bonded to the external driver 170 or the external PCB.

Also, a touch-panel protection cover 20 may be bonded to the second lateral surface of a third substrate 17 using an interlayer adhesive O.

Referring to FIG. 2, a third substrate 17, a shielding electrode pattern 18, and an outer shielding electrode interconnection 19 of a capacitive touch-screen panel may be disposed in different positions than in the capacitive touch-screen panel of FIG. 1. The shielding electrode pattern 18 and the outer shielding electrode interconnection 19 may be respectively formed in specific shapes in a specific region of a first lateral surface of the third substrate 17. The first lateral surface of the third substrate 17 may be bonded with a second lateral surface of a second substrate 11 by an interlayer adhesive O.

Furthermore, although the touch-panel protection cover 20 may be bonded to a second lateral surface of the third substrate 17 using the interlayer adhesive O, the present invention is not limited thereto. For example, the touch-panel protection cover 20 may be removed and the third substrate 17 may replace the touch-panel protection cover 20. As a result, the fabrication cost of touch screens may be effectively reduced, and the fabrication process of the touch screens may be greatly simplified.

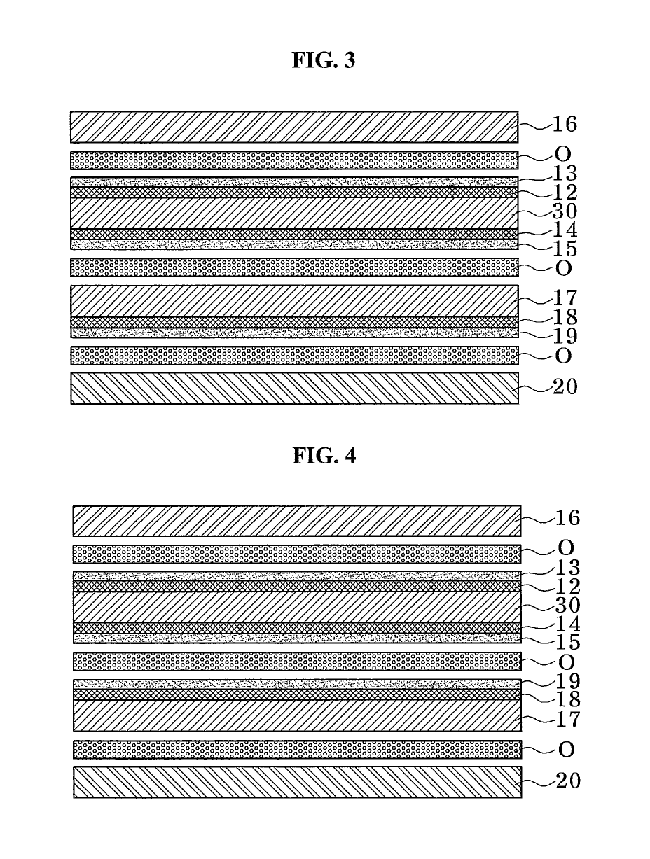

Referring to FIG. 3, a capacitive touch-screen panel, in comparison with the capacitive touch-screen panel of FIG. 1, may employ a single substrate 30 instead of the first and second substrates 10 and 11 bonded with each other by an interlayer adhesive O. A first transparent electrode pattern 12 and a first outer electrode interconnection 13 may be respectively formed in specific shapes in a specific region of a first lateral surface of the substrate 30, while a second transparent electrode pattern 14 and a second outer electrode interconnection 15 may be respectively formed in specific shapes in a specific region of a second lateral surface of the substrate 30.

Thus, the difficulty of maintaining a precise margin may be effectively overcome during the bonding of the first and second substrates 10 and 11, the fabrication cost of a touch screen may be efficiently reduced, and the fabrication process of a touch-screen panel may be greatly simplified.

Since other components have the same structures and effects as in FIG. 1, a detailed description thereof will be omitted.

Referring to FIG. 4, a third substrate 17, a shielding electrode pattern 18, and an outer shielding electrode interconnection 19 of a capacitive touch-screen panel may be disposed in different positions than in the capacitive touch-screen panel of FIG. 3. The shielding electrode pattern 18 and the outer shielding electrode interconnection 19 may be formed in specific shapes in a specific region of a first lateral surface of the third substrate 17. The first lateral surface of the third substrate 17 may be bonded with a second lateral surface of a second substrate 11 by an interlayer adhesive O.

Each of the first to third substrates 10, 11, and 17 shown in FIGS. 1 through 4 may be a transparent dielectric film formed of, for example, glass, polyimide (PI), acryl, polyethylene terephthalate (PET), or polyethylene naphthalate (PEN).

The interlayer adhesive O may be a transparent adhesive, for example, an optically clear adhesive (OCA).

Also, the window screen 16 and the touch-panel protection cover 20 may be formed using, for example, glass or PET.

Furthermore, the first and second transparent electrode patterns 12 and 14 and the shielding electrode pattern 18 may be formed of, for example, indium tin oxide (ITO), indium zinc oxide (IZO), aluminum (Al)-doped ZnO (AZO), carbon nanotubes (CNT), poly(3,4-ethylenedioxythiophene) (PEDOT), or silver (Ag) or copper (Cu) transparent ink.

In addition, the first and second outer electrode interconnections 13 and 15 and the outer shielding electrode interconnection 19 may be formed of, for example, at least one selected from the group consisting of copper (Cu), nickel (Ni), aluminum (Al), chromium (Cr), molybdenum (Mo), silver (Ag), and gold (Au).

The above-described touch screen according to the present invention may operate on the same principle as a conventional capacitive touch screen which will now be briefly described. When the window screen 16 formed of a dielectric material is touched by a finger or a specific object, a capacitance may be induced between the window screen 16 and the first transparent electrode pattern 12 and between the first and second substrates 10 and 11 (or the substrate 30) and the second transparent electrode pattern 14. A controller (refer to 160 in FIG. 5) may sense first and second-directional coordinates of a touched position of the window screen 16 based on a variation in the induced capacitance.

### Embodiment 1

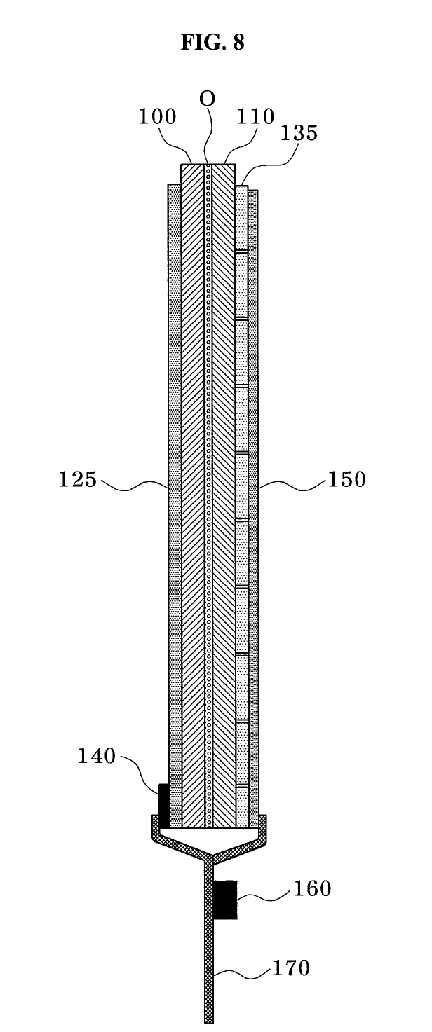

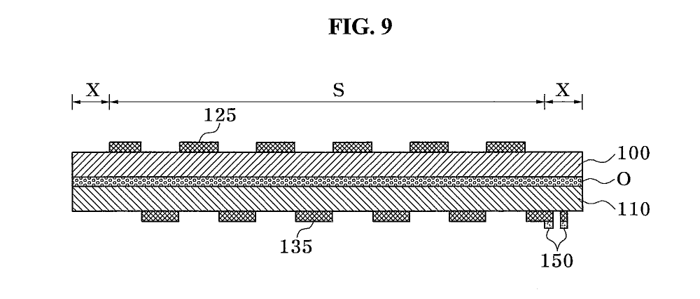

FIG. 5 is a plan view of a capacitive touch-screen panel according to a first exemplary embodiment of the present invention, FIGS. 6 and 7 are plan views of only first and second substrates of FIG. 5, respectively, FIG. 8 is a longitudinal sectional view of a capacitive touch-screen panel according to a first exemplary embodiment of the present invention, and FIG. 9 is a cross-sectional view taken along line A-A′ of FIG. 5.

Referring to FIGS. 5 through 9, a capacitive touch-screen panel may include first and second substrates 100 and 110, first and second transparent electrode panel units 120 and 130, and first and second outer electrode interconnections 140 and 150.

First lateral surfaces of the first and second substrates 100 and 110 may be bonded with each other by an interlayer adhesive O. Each of the first and second substrates 100 and 110 may include a screen region S and an inactive region X.

Each of the first and second substrates 100 and 110 may be a transparent dielectric film formed of, for example, glass, PI, acryl, PET, or PEN.

The first transparent electrode pattern unit 120 may be formed on a second lateral surface of the first substrate 100. A plurality of first transparent electrode patterns 125 may be electrically connected to one another in a lengthwise direction such that vertices of a plurality of triangular or rectangular sensing pads SP are spaced a predetermined distance apart from one another. Also, the plurality of first transparent electrode patterns 125 may be spaced a predetermined distance apart from one another in a widthwise direction.

The second transparent electrode pattern unit 130 may be formed on a screen region S of a second lateral surface of the second substrate 110. A plurality of second transparent electrode patterns 135 may be electrically connected to one another in a widthwise direction such that vertices of a plurality of triangular or rectangular sensing pads SP are spaced a predetermined distance apart from one another. The plurality of second transparent electrode patterns 135 may be spaced a predetermined distance apart from one another in a lengthwise direction at right angles to one another between the respective first transparent electrode patterns 125. Thus, from the plan view, the first and second substrates 100 and 110 may form a right-angled grating shape.

Each of the first and second transparent electrode pattern units 120 and 130 may be formed of, for example, ITO, IZO, AZO, CNTs, a conductive polymer such as PEDOT, or Ag or Cu transparent ink.

Meanwhile, although the sensing pad SP may be formed in the shape of, for example, a triangle, a rectangle, or a lozenge, the present invention is not limited thereto and the sensing pad SP may be formed in various other shapes, for example, a circle, an ellipse, or a polygon.

The first outer electrode interconnection 140 may be disposed on the inactive region X of a second lateral surface of the first substrate 100 and electrically connected to each of first transparent electrode patterns 125 of the first transparent electrode pattern unit 120.

The second outer electrode interconnection 150 may be disposed on the inactive region X of a second lateral surface of the second substrate 110 and electrically connected to each of second transparent electrode patterns 135 of the second transparent electrode pattern unit 130.

In order to drive and control the entire touch-screen panel, a double-sided external driver (e.g., flexible printed circuit (FPC) or chip on film (COF)) 170 having a controller 160 may be bonded to both inactive regions X formed on second lateral surfaces of the first and second substrates 100 and 110. The double-sided external driver 170 having the controller 160 may be electrically connected to each of the first and second outer electrode interconnections 140 and 150.

Also, the capacitive touch-screen panel may further include a transparent substrate (not shown) and a shielding electrode pattern (refer to 18 in FIG. 1) configured to remove a noise signal. The transparent substrate may have a screen region S and an inactive region X. The transparent substrate, which may correspond to the third substrate 17 of FIG. 1, may have a first lateral surface bonded to the second lateral surface of the second substrate 110. The shielding electrode pattern 18 configured to remove the noise signal may be formed in a screen region S of a second lateral surface of the transparent substrate.

Furthermore, the capacitive touch-screen panel may further include an outer shielding electrode interconnection (refer to 19 in FIG. 1). The outer shielding electrode interconnection 19 may be formed in the inactive region X of the second lateral surface of the transparent substrate and electrically connected to the shielding electrode pattern 18. Meanwhile, the shielding electrode pattern 18 may be formed in the shape of, for example, a plate or a mesh. Also, as shown in FIG. 2, the positions of the transparent substrate, the shielding electrode pattern 18, and the outer shielding electrode interconnection 19 may be changed.

### Embodiment 2

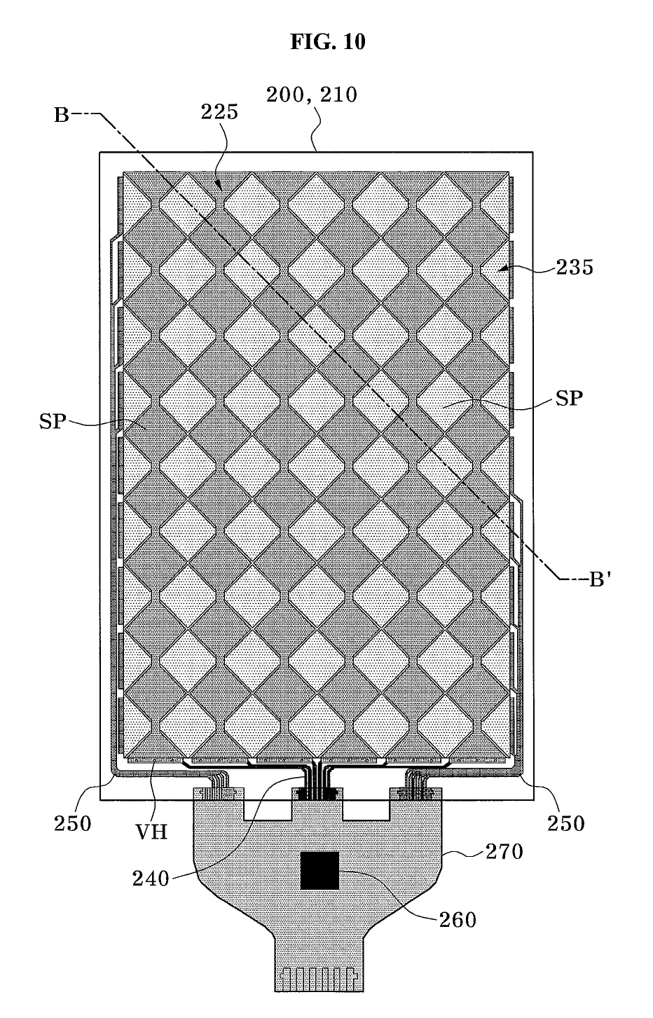

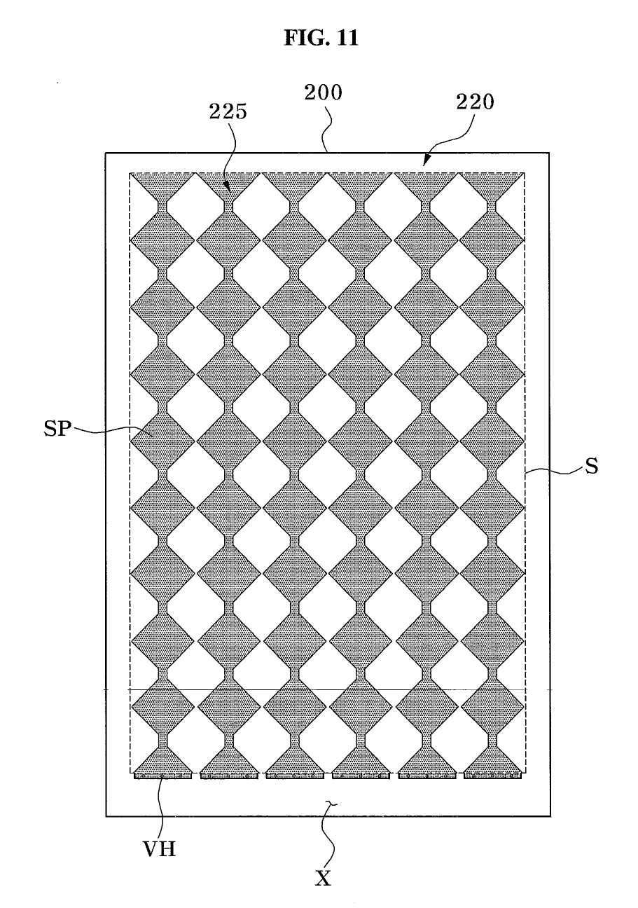

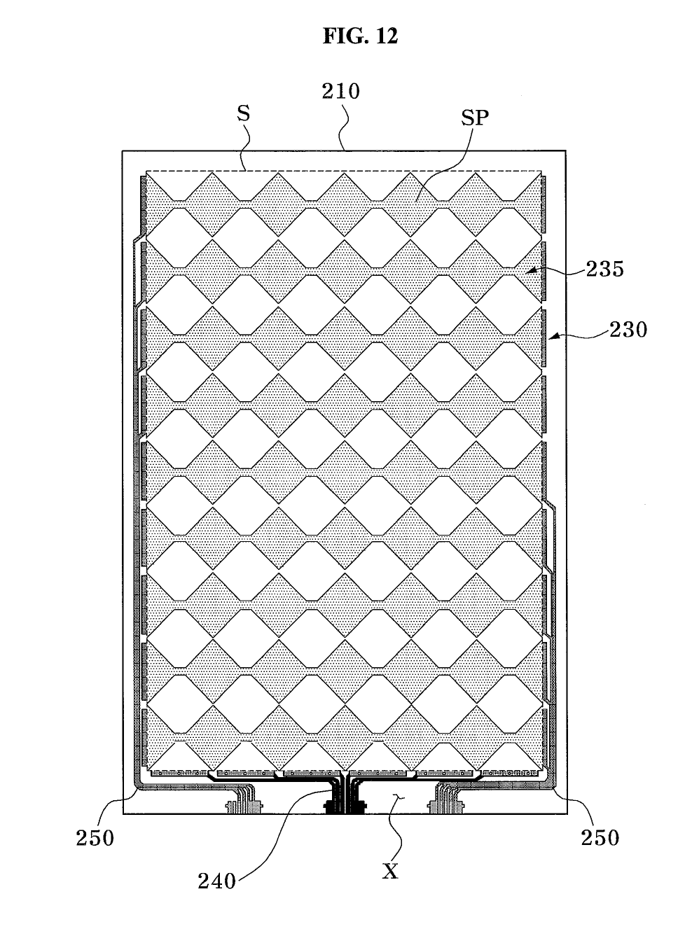

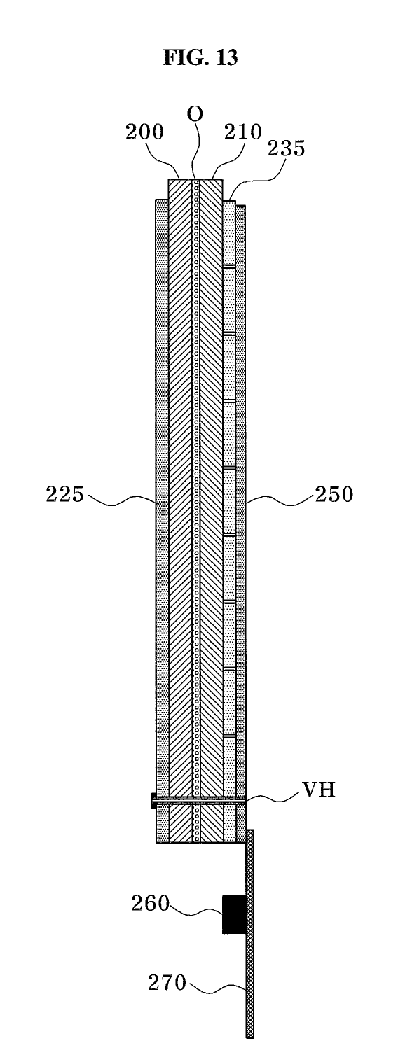

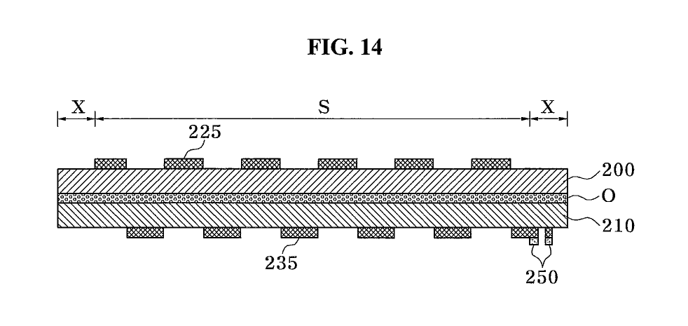

FIG. 10 is a plan view of a capacitive touch-screen panel according to a second exemplary embodiment of the present invention, FIGS. 11 and 12 are plan views of only first and second substrates of FIG. 10, respectively, FIG. 13 is a longitudinal sectional view of a capacitive touch-screen panel according to a second exemplary embodiment of the present invention, and FIG. 14 is a cross-sectional view taken along line B-B′ of FIG. 10.

Referring to FIGS. 10 through 14, a capacitive touch-screen panel according to a second exemplary embodiment of the present invention may include first and second substrates 200 and 210, first and second transparent electrode pattern units 220 and 230, and first and second outer electrode interconnections 240 and 250.

Since the first and second substrates 200 and 210 and the first and second transparent electrode pattern units 220 and 230 are the same as in the previously described first exemplary embodiment, a detailed description thereof will be omitted here.

In particular, the capacitive touch-screen panel according to the second exemplary embodiment of the present invention may be configured such that a single-sided external driver 270 is bonded. Thus, the first outer electrode interconnection 240 may be formed on an inactive region X of a second lateral surface of the second substrate 210 and electrically connected to each first transparent electrode pattern 225 of the first transparent electrode pattern unit 220 through at least one via hole VH formed in the inactive regions X of the first and second substrates 220 and 210.

The second outer electrode interconnection 250 may be disposed on the inactive region X of the second lateral surface of the second substrate 210 and electrically connected to each of second transparent electrode patterns 235 of the second transparent electrode pattern unit 230.

In order to drive and control the entire touch-screen panel, a single-sided external driver 270 having a controller 260 may be bonded to one of the inactive regions X of the second lateral surfaces of the first and second substrates 200 and 210. The single-sided external driver 270 having the controller 260 may be electrically connected to each of the first and second outer electrode interconnections 240 and 250.

Although FIG. 10 illustrates that the external driver 270 having the controller 260 is bonded to protrude outward, the present invention is not limited thereto. For example, the single-sided external driver 270 having the controller 260 may not protrude outward but be bonded to one of upper portions of the inactive regions X of the second lateral surfaces of the first and second substrates 200 and 210.

Also, the capacitive touch-screen panel may further include a transparent substrate (not shown) and a shielding electrode pattern (refer to 18 in FIG. 1) configured to remove a noise signal. The transparent substrate (which may correspond to the third substrate 17 of FIG. 1) may have a first lateral surface bonded to the second lateral surface of the second substrate 210 using an interlayer adhesive O (refer to FIG. 1). The transparent substrate may have a screen region S and an inactive region X. The shielding electrode pattern 18 configured to remove the noise signal may be formed in the screen region S of a second lateral surface of the transparent substrate.

Furthermore, the capacitive touch-screen panel may further include an outer shielding electrode interconnection (refer to 19 in FIG. 1). The outer shielding electrode interconnection 19 may be formed in the inactive region X of the second lateral surface of the transparent substrate and electrically connected to the shielding electrode pattern 18. For example, the shielding electrode pattern 18 may be formed in a plate or mesh shape. As shown in FIG. 2, the positions of the transparent substrate, the shielding electrode pattern 18, and the outer shielding electrode interconnection 19 may be changed.

Meanwhile, the first and second exemplary embodiments describe that the first and second substrates 100 and 200 (or 200 and 210) are bonded to each other by the interlayer adhesive O, but the present invention is not limited thereto. For example, as shown in FIGS. 3 and 4, a single substrate 30 may be employed without using the interlayer adhesive 30.

According to the above-described capacitive touch-screen panel of the present invention, malfunctions due to a contact with an upper portion of an electrode unit of a touch screen or malfunctions and damage caused by scratches and static electricity during the contact with the touch screen can be prevented, the fabrication cost of the touch screen can be efficiently reduced, and the fabrication process of the touch-screen panel can be greatly simplified.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A capacitive touch-screen panel comprising:
a first substrate having a screen region and an inactive region;
a first transparent electrode pattern unit disposed in the screen region of a first lateral surface of the first substrate;
a first outer electrode interconnection formed in the inactive region of the first lateral surface of the first substrate and electrically connected to the first transparent electrode pattern unit;
a second substrate having a first lateral surface bonded with a second lateral surface of the first substrate using an interlayer adhesive, the second substrate having a screen region and an inactive region;
a second transparent electrode pattern unit disposed on the screen region of a second lateral surface of the second substrate; and
a second outer electrode interconnection formed in the inactive region of a second lateral surface of the second substrate and electrically connected to the second transparent electrode pattern unit,
wherein the capacitive touch-screen panel is configured to sense a touched position with a variation in capacitance due to a contact with the first and second transparent electrode pattern units.

2. A capacitive touch-screen panel comprising:
a first substrate having a screen region and an inactive region;
a first transparent electrode pattern unit disposed in the screen region of a first lateral surface of the first substrate;
a second substrate having a first lateral surface bonded with a second lateral surface of the first substrate, the second substrate having a screen region and an inactive region;
a second transparent electrode pattern unit disposed in the screen region of a second lateral surface of the second substrate;
a first outer electrode interconnection disposed in the inactive region of the second lateral surface of the second substrate and electrically connected to the first transparent electrode pattern unit through at least one via hole; and
a second outer electrode interconnection disposed in the inactive region of the second lateral surface of the second substrate and electrically connected to the second transparent electrode pattern unit,
wherein the capacitive touch-screen panel is configured to sense a touched position with a variation in capacitance due to a contact with the first and second transparent electrode pattern units.

3. The capacitive touch-screen panel of claim 2, wherein an external driver is bonded to the inactive region of the second lateral surface of the second substrate and electrically connected to the first and second outer electrode interconnections.

4. The capacitive touch-screen panel of any one of claim 1 or claim 2, further comprising:
a transparent substrate having a first lateral surface bonded to the second lateral surface of the second substrate by an interlayer adhesive, the transparent substrate having a screen region and an inactive region; and
a shielding electrode pattern configured to remove a noise signal and disposed in the screen region of a second lateral surface of the transparent substrate.

5. The capacitive touch-screen panel of claim 4, further comprising an outer shielding electrode interconnection disposed in the inactive region of the second lateral surface of the transparent substrate and electrically connected to the shielding electrode pattern.

6. The capacitive touch-screen panel of any one of claim 1 or claim 2, further comprising:
a transparent substrate having a screen region and an inactive region;
a shielding electrode pattern configured to remove a noise signal and disposed in the screen region of a first lateral surface of the transparent substrate; and
an outer shielding electrode pattern disposed in the inactive region of the first lateral surface of the transparent substrate and electrically connected to the shielding electrode pattern,
wherein the first lateral surface of the transparent substrate on which the shielding electrode pattern and the outer shielding electrode interconnection are disposed is bonded to the second lateral surface of the second substrate by an interlayer adhesive.

7. The capacitive touch-screen panel of any one of claim 1 or claim 2, wherein each of the first and second substrates is a transparent film formed of at least one selected from the group consisting of glass, polyethylene terephthalate (PET), polyethylene naphthalate (PEN), polyimide (PI), and acryl.

8. A capacitive touch-screen panel comprising:
a substrate having a screen region and an inactive region;
first and second transparent electrode pattern units respectively disposed in the screen regions of first and second lateral surfaces of the substrate; and
first and second outer electrode interconnections disposed in the inactive regions of the first and second lateral surfaces of the substrate and electrically connected to the first and second transparent electrode pattern units, respectively,
wherein the capacitive touch-screen panel is configured to sense a touched position with a variation in capacitance due to a contact with the first and second transparent electrode pattern units.

9. A capacitive touch-screen panel comprising:
a substrate having a screen region and an inactive region;
first and second transparent electrode pattern units respectively disposed in the screen regions of first and second lateral surfaces of the substrate;
a first outer electrode interconnection disposed in the inactive region of the second lateral surface of the substrate and electrically connected to the first transparent electrode pattern unit through at least one via hole; and
a second outer electrode interconnection disposed in the inactive region of the second lateral surface of the substrate and electrically connected to the second transparent electrode pattern unit,
wherein the capacitive touch-screen panel is configured to sense a touched position with a variation in capacitance due to a contact with the first and second transparent electrode pattern units.

10. The capacitive touch-screen panel of claim 9, wherein an external driver is bonded to the inactive region of the second lateral surface of the substrate and electrically connected to the first and second outer electrode interconnections.

11. The capacitive touch-screen panel of any one of claim 8 or claim 9, further comprising:
a transparent substrate having a first lateral surface bonded to the second lateral surface of the substrate by an interlayer adhesive, the transparent substrate having a screen region and an inactive region; and
a shielding electrode pattern configured to remove a noise signal and disposed in the screen region of the lateral surface of the transparent substrate.

12. The capacitive touch-screen panel of claim 11, further comprising an outer shielding electrode interconnection disposed in the inactive region of the second lateral surface of the transparent substrate and electrically connected to the shielding electrode pattern.

13. The capacitive touch-screen panel of any one of claim 8 or claim 9, further comprising:
a transparent substrate having a screen region and an inactive region;
a shielding electrode configured to remove a noise signal and disposed in the screen region of the first lateral surface of the transparent substrate; and
an outer shielding electrode interconnection disposed in the inactive region of the first lateral surface of the transparent substrate and electrically connected to the shielding electrode pattern,
wherein the first lateral surface of the transparent substrate on which the shielding electrode pattern and the outer shielding electrode interconnection are disposed is bonded to a second lateral surface of the substrate by an interlayer adhesive.

14. The capacitive touch-screen panel of any one of claim 8 or claim 9, wherein the substrate is a transparent film formed of at least one selected from the group consisting of glass, PET, PEN, PI, and acryl.

15. The capacitive touch-screen panel of any one of claim 1, claim 2, claim 8 or claim 9, wherein each of the first and second transparent electrode pattern units is formed of at least one selected from the group consisting of indium tin oxide (ITO), indium zinc oxide (IZO), aluminum (Al)-doped ZnO (AZO), carbon nanotubes (CNT), poly(3,4-ethylenedioxythiophene) (PEDOT), silver (Ag) transparent ink, and copper (Cu) transparent ink.

16. The capacitive touch-screen panel of any one of claim 1 claim 2, claim 8 or claim 9, wherein a plurality of first transparent electrode patterns of the first transparent electrode pattern unit are spaced a predetermined distance apart from one another in a widthwise direction and connected to one another in a lengthwise direction such that vertices of a plurality of triangular or rectangular sensing pads are spaced a predetermined distance apart in a lengthwise direction, and a plurality of second transparent electrode patterns of the second transparent electrode pattern unit are spaced a predetermined distance apart from one another in a lengthwise direction at right angles to one another between the respective first transparent electrode patterns and connected to one another in a widthwise direction such that vertices of a plurality of triangular or rectangular sensing pads are spaced a predetermined distance apart from each other so that the first and second transparent electrode pattern units form a right-angled grating shape.

17. The capacitive touch-screen panel of any one of claim 4, claim 6, claim 11 or claim 13, wherein the shielding electrode pattern is formed in a plate or mesh shape.
